(19) United States
(12) Patent Application Publication
(10) Pub. No.: US 2018/0139910 A1
(43) Pub. Date: May 24, 2018

(54) MODULAR TREE PROTECTING CONTAINER ENSEMBLE

(71) Applicants: Ketty Mobed, San Francisco, CA (US); Jafar Yaghoobi, San Francisco, CA (US)

(72) Inventors: Ketty Mobed, San Francisco, CA (US); Jafar Yaghoobi, San Francisco, CA (US)

(21) Appl. No.: 15/356,576

(22) Filed: Nov. 19, 2016

(51) Int. Cl. A01G 13/02; A01G 13/10; A01G 17/00

(52) U.S. Cl. CPC A01G 13/0237; A01G 17/00; A01G 13/10

(57) ABSTRACT

A modular tree protecting container ensemble consists of eight arcuate and straight connectable modular containers, which when set up and connected to each other around a tree at soil level, provides a protective barrier, forms a water and mulch basin, provides theft-resistance and allows for beautification. The ensemble includes three unique shapes, two of which are corner containers; all three shapes have drainage holes on the container floor, and have identical sidewalls and sidewall connector holes for perfect container-to-container alignment. The tree protecting container ensemble is made up of two corner containers with both arcuate walls, two corner containers with arcuate and right angle-cornered walls, and four straight-sided containers, which are all fastened to each other through their sidewall holes with spacers, rods and rod caps, providing container-to-container connection, ensemble stability and theft-resistance.

### CROSS-REFERENCE TO RELATED APPLICATIONS RELATED APPLICATIONS

Not applicable

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable

### STATEMENT REGARDING PRIOR DISCLOSURES BY THE INVENTOR OR A JOINT INVENTOR

Not applicable

### FIELD OF THE INVENTION

The present invention relates to tree protection in general, and to a modular tree protecting container ensemble surrounding a tree at soil level in particular.

### BACKGROUND OF THE INVENTION

Trees are living organisms and are vital components of our garden- and cityscapes. Trees are natural air purifiers, improving air quality. Trees beautify urban and suburban neighborhoods and public spaces. Trees have been shown to promote the general well being of people and positively impact the environment as a whole. Based on these reasons, homeowners and urban and suburban municipalities and neighborhoods are increasingly planting more trees. However, trees, particularly unprotected sidewalk trees are also exposed to a multitude of abusive and damaging factors such as manual and power garden tools and machinery, pedestrian and skateboarder traffic, chained cycles, opening car doors, and unsightly and unsanitary dog waste. In addition, many city ordinances mandate specifically sized sidewalk tree wells depending on the width of the sidewalk, which home and property owners need to adhere to.

While homeowners and municipalities do set up the areas of tree wells for planting and maintaining trees on the sidewalks and in gardens, there are no practical tree protecting apparati on the market, that are modular and expandable for a growing tree, while also providing a mulching and watering basin, preventing water run-off, are theft-resistant, and at the same time give the opportunity to non-invasively decorate and beautify the area around the tree.

The inventors have therefore recognized the aforementioned tree protection problems and in their research have observed a lack in the art and the need for modular expandable tree protecting container ensembles that are easily set up, are sturdy, theft-resistant, and simultaneously would provide the means to beautify around the tree base and protect the tree roots.

### BRIEF SUMMARY OF THE INVENTION

The inventors have identified the specific issues associated with protection and maintenance of trees, such as watering and mulching, and injuries and damage that commonly occur to street and garden trees. The inventors have addressed this need by developing a modular tree protecting container ensemble that allows for simple, theft-resisting inter-connection of modular open top containers around the tree base at soil level, while offering the possibility to expand the container ensemble with additional inter-connectable open top containers as the tree grows in width or if the tree well dimensions change. At the same time the modular tree protecting container ensemble offers the opportunity to decorate and beautify the tree area without encroaching on the tree root system.

The present embodiment of the modular tree protecting container ensemble includes a total of eight containers with three distinct container shapes, two of which are designed to be corner containers. The first corner container is quarter-circle arcuate on both inner and outer length-side walls. The second corner container is quarter-circle arcuate on the inner length-side wall and right angle-cornered on the two outer walls. The third container has straight-sided inner and outer walls. According to the tree owners' further needs, additional straight-sided containers can be inserted in order to expand the modular tree protecting container ensemble. All containers have identical sidewalls with equal-sized connection holes identically located along the sidewall's midline for perfect container-to-container alignment and interconnection. Each container has three equidistant drainage holes on the midline of the container floor to provide uniform drainage for water run-off. The modular containers are set up around a tree trunk at soil level and are aligned by their equal-sized sidewalls and equal-sized and spaced sidewall holes and are fastened to each other with common use, non-corrosive spacers, rods and rod caps through the aligned sidewall holes. This interconnection method provides ensemble stability and theft resistance.

Furthermore, the described features and advantages of the disclosure may be combined in various manners and embodiments, as already mentioned, as one skilled in the relevant art will recognize. The disclosure can be practiced without one or more of the features and advantages described in a particular embodiment.

Further advantages of the present disclosure will become apparent from a consideration of the drawings and ensuing description.

### BRIEF DESCRIPTION OF THE DRAWINGS

FIG. 1 is a perspective view of the modular tree protecting container ensemble of the present invention;

FIG. 2 is a top view of the modular tree protecting container ensemble;

FIG. 3A is a perspective view of the modular corner container with arcuate inner and outer length-side walls;

FIG. 3B is a perspective view of the modular corner container with an arcuate inner length-side wall and two straight right angle-cornered outer length-side walls;

FIG. 3C is a perspective view of the straight-sided container;

FIG. 4 is a front view of the sidewall identical to all the modular containers;

FIG. 5 is a partial cross-sectional view of the sidewall showing the interconnection between two containers with common-use spacers, a rod, and a rod cap.

### DESCRIPTIVE KEY

10 modular tree protecting container ensemble
20 modular corner container with arcuate inner and outer length-side wall
25 quarter-circle arcuate inner length-side wall
26 quarter-circle arcuate outer length-side wall
27 floor of modular corner container with arcuate length-side walls
30 modular corner container with arcuate inner length-side wall and right angle-cornered outer length-side walls
35 quarter-circle arcuate inner length-side wall
36 right angle-cornered outer length-side wall
37 floor of modular corner container with right angle-cornered outer length-side wall
40 modular container with straight inner and outer length-side walls
45 straight length-side wall
47 floor of modular straight-sided container
50 drainage hole
60 side wall
65 side wall connector hole
70 common-use spacer
80 common-use rod
90 common-use rod cap

### DETAILED DESCRIPTION OF THE INVENTION

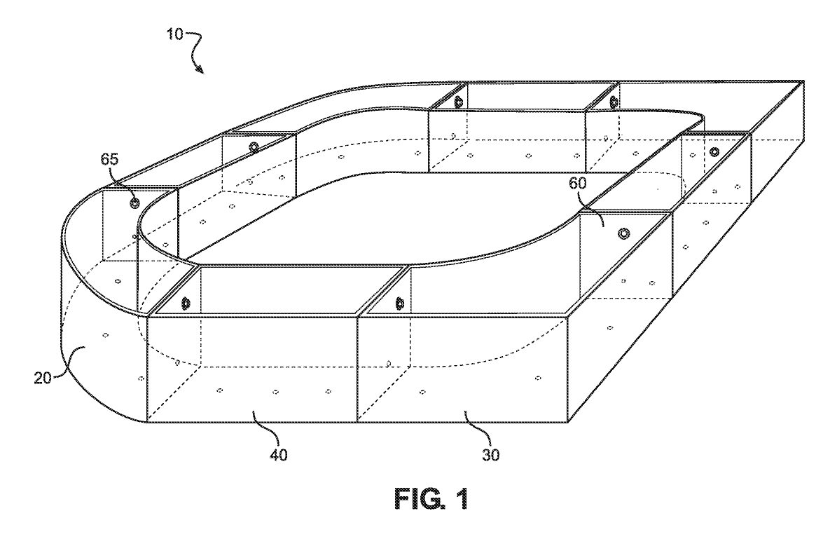

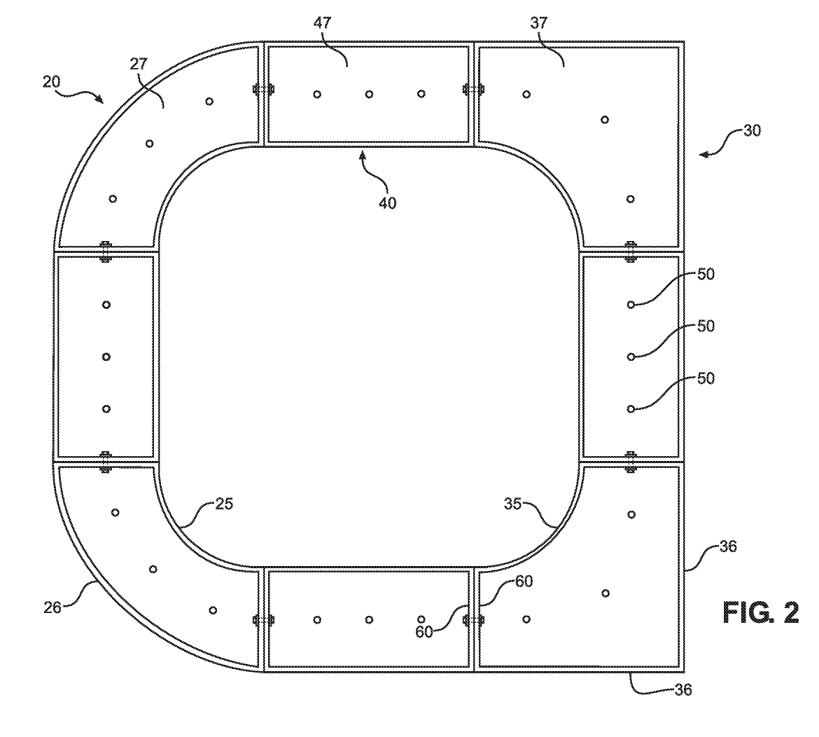

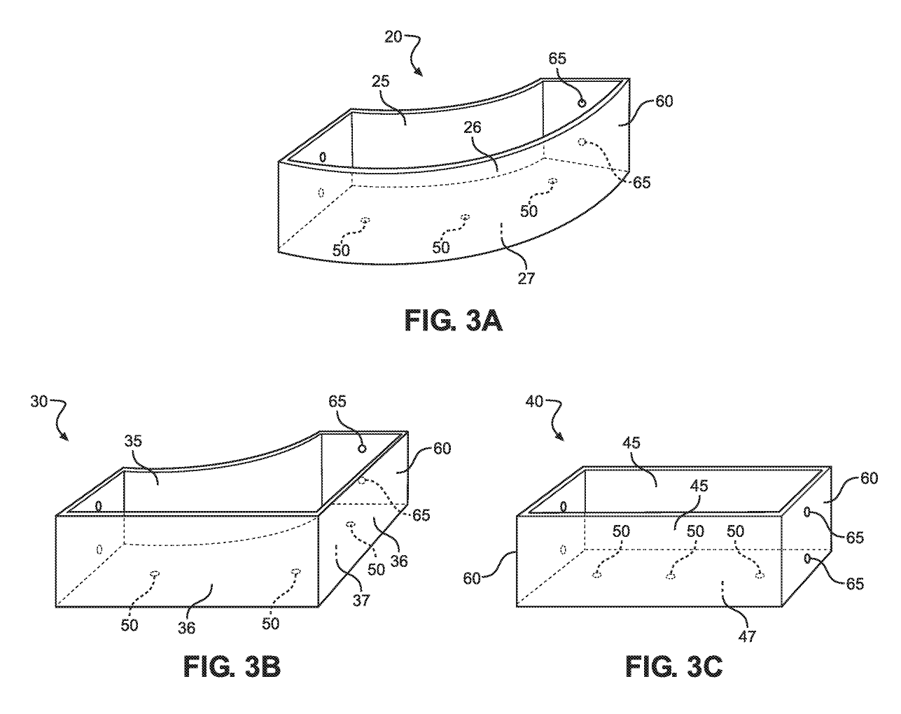

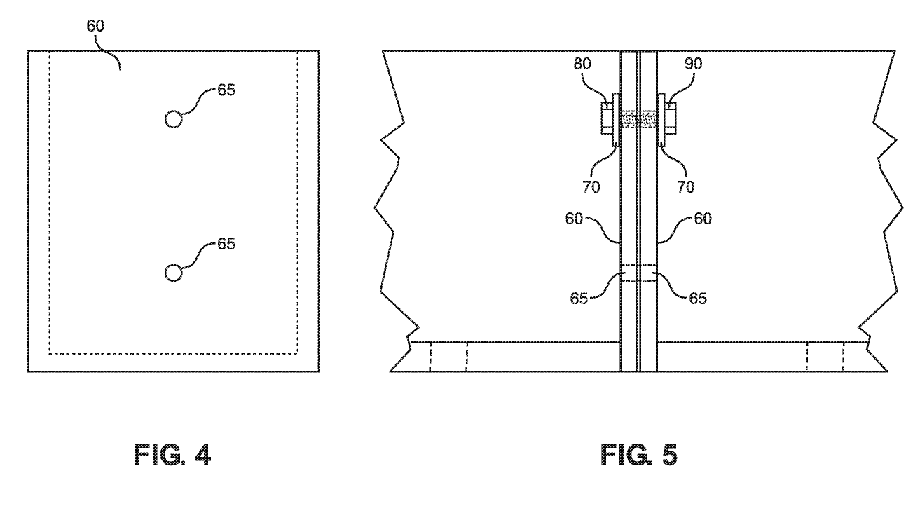

The detailed description of the modular tree protecting container ensemble (herein described as an “ensemble”) are displayed in seven drawings, FIG. 1, FIG. 2, FIG. 3A, FIG. 3B, FIG. 3C, FIG. 4, and FIG. 5, which are briefly described above. The bolded numbers in the detailed description refer to the Descriptive Key, labels of all the ensemble pieces as listed above. In accordance with the invention, the present disclosure describes a certain embodiment of the ensemble 10 which provides a protective barrier, mulching and watering basin for trees, while providing a non-invasive and drainable beautification area and theft-resistance.

In accordance with the invention, the best mode of the ensemble 10 is presented in terms of a preferred embodiment, herein depicted in FIG. 1 and FIG. 2, which is made up of a total of eight containers that are all of equal height, of which two corner containers 20 are quarter-circle arcuate on both outer and inner length-side walls, and of which two corner containers 30 are quarter-circle arcuate on the inner length-side wall and have right angle-cornered outer length-side walls, and of which four containers are straight-sided 40. However, the disclosure is not limited to this single described embodiment and a person skilled in the art will appreciate that many other embodiments are possible without deviating from the basic concept of the disclosure and that such work around will also fall under its scope. It is envisioned that other configurations can be easily incorporated into the teachings of the present disclosure, and only one particular configuration is shown and described for purposes of clarity and disclosure and not by way of limitation of scope.

FIG. 1 depicts the ensemble 10 as seen from a perspective view. The ensemble is comprised of eight containers with three distinct shapes 20, 30 and 40. There are two arcuate types of corner containers 20 and 30, and one straight walled container 40. All containers have equal sized identical opposite sidewalls 60, all of which have two equal-sized and equal spaced holes 65 on the sidewalls' midline for perfect hole-to-hole, container-to-container alignment.

FIG. 2 is the top view of the ensemble 10 of the present embodiment. Both shapes of corner containers 20 and 30 have identically sized quarter-circle arcuate inner length-side walls 25 and 35. One of the two types of corner containers 20 has an outer quarter-circle arcuate length-side wall 26. The other type of corner container 30 has equal length right angle-cornered length-side outer walls 36. Four identical straight-walled containers 40 with both inner and outer straight-sided walls 45 complete the ensemble 10 described herein. The ensemble 10 can be expanded in size by additionally inserting the straight-sided containers 40. The containers 20, 30, and 40 all have three drainage holes 50 and are located equally spaced along the mid section of the container floors 27, 37 and 47 to provide uniform drainage and to prevent water accumulation in the container. All the sidewalls 60 of the three different containers 20, 30, and 40 are identical. After the containers are set up around the tree base at soil level and fastened to each other, mulch and water can be added to the area between the tree trunk and the ensemble 10 for tree maintenance, and soil, sand, pebbles, rocks or other filling material and plants can be added to the containers 20, 30 and 40 to decorate and beautify the area around the tree.

FIGS. 3A, 3B, and 3C illustrate in detail the three different uniquely shaped modular ensemble containers, all with identical sidewalls 60 and connector holes 65 for perfect container-to-container alignment and connection.

FIG. 3A is a detailed perspective view of the corner container 20 with the quarter-circle arcuate inner length-side wall 25 and quarter-circle arcuate outer length-side wall 26. Three equal-sized and equal-spaced drainage holes 50 along the the planting container floor 27 provide uniform drainage.

FIG. 3B is a detailed perspective view of the corner container with the quarter-circle arcuate inner length-side wall 35 and with two same-length right angle-cornered outer length-side walls 36. Three equal-sized and equal-spaced drainage holes 50 along the the container floor 37 provide uniform drainage.

FIG. 3C is a detailed view of the container with equal sized inner and outer straight-sided length-side walls 45. Three equal-sized and equal-spaced drainage holes 50 along the the planting container floor 47 provide uniform drainage. Additional straight-sided containers 40 can be inserted between the corner containers 20 and 30 to enlarge the tree protecting container ensemble for trees with larger trunks or larger tree well requirements.

FIG. 4 is the front view of the sidewall 60 with two equal-sized and equal-spaced connector holes 65 that are located midline on the sidewall 60. The sidewalls 60 and connector holes 65 are identical in all the containers 20, 30 and 40, for perfect sidewall hole to sidewall hole container-to-container alignment.

FIG. 5 is a partial cross-sectional view of two sidewalls 60 of two adjoining containers depicting the fastening of the containers to each other with one common-use non-corrosive rod 80, one common-use non-corrosive rod cap 90, and a common-use non-corrosive spacer 70 placed in-between the rod 80 and the inside container side wall 60, and a common-use non-corrosive spacer 70 placed in-between the rod cap 90 and the inside container side wall 60, through the aligned sidewall holes 65 of the two containers. This container inter-fastening method provides both ensemble stability and theft resistance.

Individual containers described herewith may be formed from plastic, wood, ceramic, clay, various metals, or other like material.

1. At least three modular tree protecting containers that may together form a joined container ensemble, comprising:
a plurality of at least three differently shaped open top containers, each with a cavity surrounded by an inner wall, at least one outer wall, a pair of sidewalls of substantially equal lengths, and a bottom floor, the differently shaped containers comprising
first corner containers with arcuate inner and outer walls,
second corner containers with arcuate inner walls and right angled outer walls, and
extension containers with straight equal length inner and outer walls,
wherein the containers when aligned by sidewalls around a tree trunk at soil level, with the first and second corner containers with arcuate inner walls facing the tree trunk, with one or more straight-sided extension containers in-between the corner containers form the container ensemble that partially or fully circumscribe an enclosed circular or oval shaped area around the tree trunk thereby
providing
a protective barrier for the tree trunk and
an optional enclosed area for mulching and watering the tree.

2. The modular containers as in claim 1, wherein each container has a floor with a plurality of equidistant holes to allow uniform drainage of water.

3. The modular containers as in claim 1, wherein the sidewalls of every container have identical measurements in height and length.

4. The modular containers as in claim 3, wherein the sidewalls of every modular container have a plurality of holes with equal diameter and are placed and spaced identically on each sidewall to allow precise alignment for purposes of connecting the said modular containers and form the joined ensemble.

5. The modular containers of claim 4, being fastened to each other through the sidewall holes by a plurality of fastening devices, one means being common use doughnut shaped spacers, rods and rod caps, the size of the said spacers, rods and rod caps being predetermined by the diameter of the container sidewall holes to improve alignment, stabilization and to implement theft resistance for the ensemble.

6. The modular containers as in claim 5, further comprising a connection between said modular containers that is accomplished through the sidewall holes by putting one rod through one spacer through two aligned modular containers and their sidewall holes and a second spacer and fastened off by a rod cap at the end of the rod.

7. The modular containers as in claim 1, wherein wall thicknesses of the five sidings of every modular container is pre-determined based on the fabrication material used, to withstand the weight and minimum pressure of sand for the purpose of filling the cavity of the container to the top with sand or a plurality of other filling or decorating material.

8. The containers of claim 1, comprising at least four containers.

9. The containers of claim 1, comprising at least five containers.

10. The containers of claim 1, comprising at least six containers.

11. The containers of claim 1, comprising at least seven containers.

12. The containers of claim 1, comprising at least eight containers.

13. At least three modular tree protecting containers that may together form a joined container ensemble, comprising:
a plurality of at least two differently shaped open top containers, each with a cavity surrounded by an inner wall, at least one outer wall, a pair of sidewalls of substantially equal lengths, and a bottom floor, the differently shaped containers comprising
at least one first corner container with arcuate inner and outer walls,
at least one second corner container with arcuate inner walls and right angled outer walls, and
an optional extension containers with straight equal length inner and outer walls
wherein the containers when aligned by sidewalls around a tree trunk, with the first and second corner containers with arcuate inner walls facing the tree trunk, with one or more straight-sided extension containers in-between the corner containers form the container ensemble that partially or fully circumscribe a circular or oval shaped area around the tree trunk thereby providing a protective barrier for the tree trunk.

14. At least four modular tree protecting containers that may together form a joined container ensemble, comprising:
a plurality of at least two differently shaped open top containers, each with a cavity surrounded by an inner wall, at least one outer wall, a pair of sidewalls of substantially equal lengths, and a bottom floor, the differently shaped containers comprising
at least one first corner container with arcuate inner and outer walls, and
at least one second corner container with arcuate inner walls and right angled outer walls,
wherein the containers when aligned by sidewalls around a tree trunk, with the first and second corner containers with arcuate inner walls facing the tree trunk form the container ensemble that partially or fully circumscribe a circular or oval shaped area around the tree trunk thereby providing a protective barrier for the tree trunk.
